(19) United States
(12) Patent Application Publication
(10) Pub. No.: US 2002/0063740 A1
(43) Pub. Date: May 30, 2002

(54) Method to unobscure vision caused by the mouse pointer positioning within a document being displayed by a computer system

(76) Inventors: Randolph Michael Forlenza, Austin, TX (US); Herman Rodriguez, Austin, TX (US); Frank J. Schroeder, Round Rock, TX (US)

Correspondence Address: Andrew J. Dillon, FELSMAN, BRADLEY, VADEN, GUNTER & DILLON, LLP, Lakewood on the Park, Suite 350, 7600B North Capital of Texas Highway, Austin, TX, 78731, US

(21) Appl. No.: 09/726,267

(22) Filed: Nov. 30, 2000

(51) Int. Cl. G09G 5/00

(52) U.S. Cl. 345/856

(57) ABSTRACT

When a user actuates a first control input signaling the user's desire to see the cursor prominently displayed, a cursor display control module displays the pointer-driven cursor in a predetermined display position prominently visible to the user. The prominence of the cursor may be enhanced, for example, by changing the cursor's display attributes, and/or changing the background color or pattern in the area around the cursor. When the user actuates a second control input signaling the user's desire to reduce visibility of the pointer-driven cursor, the cursor display control module obscures the pointer-driven cursor, for example, by moving the pointer-driven cursor to a less prominent position in the display, by changing the color of the pixels that represent the pointer-driven cursor to reduce its visibility, or both.

### BACKGROUND OF THE INVENTION

1. Technical Field

The present invention relates generally to controlling displays in data processing systems and in particular to adjusting the visibility of cursors in the user interface of data processing systems. Still more particularly, the present invention relates to selectively reducing or increasing the visibility of a pointer-driven cursor in a display.

2. Description of the Related Art

The introduction of graphical user interfaces (GUIs) in the early 1980's marked a substantial change in the way in which users interacted with data processing systems. In addition to a cursor driven by the keyboard, information could be entered and commands issued by the user through pointing devices and pointer-driven cursors. Currently, graphical user interfaces have become so prevalent in the computing industry as to be essential to the average user in interacting with a data processing system.

Problems with graphical user interfaces have always existed because the pointer-driven cursor is a small, mobile, and generally opaque element of the screen environment. The pointer-driven cursor's small size and mobility sometimes cause the pointer-driven cursor to become visually lost in the screen environment, while the opacity causes the cursor to interfere with viewing content. When using a system with a pointing device such as a mouse, trackball, and the like, occasionally the cursor will be positioned at the outer extremes of the display. In some cases the cursor may become invisible since the logical location lies outside the boundaries of the display.

At other times, the cursor becomes an obstruction to reading a portion of a document behind the position where the cursor is being displayed. Generally a user spends little time considering where to move the cursor when it is in the way, but simply moves the cursor. As a result, the cursor seems to frequently end up obscuring text which the user desires to read. The problem is exacerbated as the environment changes (e.g., windows on the desktop are replaced, moved, or changed in size), and the user must repeatedly move the cursor in order to keep reading.

FIG. 4 illustrates the problems of the prior art regarding visibility of a pointer-driven cursor. A display unit 400, such as a monitor, presumably attached to a data processing system (not shown), has a visible area 402 where a user application image 404 is displayed. Such display is accomplished by activating pixels inside the monitor which correspond to a logical and mathematical representation—a mapping—of the screen viewed by the user. In order to display the application image 404, a logical data structure is created that represents the image in terms of the pixels in the display unit 400 that need to be activated (as well as the colors to activate) to produce a visible image recognizable by the user as the desired application image 404. The algorithms that produce these images can be exceedingly detailed and complex.

A problem arises when the logical mapping area used by the operating system to create an application image 404 is larger than the visible area 402, resulting in a logical area 406 comprised of pixels that exist in the logical and mathematical representation used to create the user application image but which are not displayed on the display unit 400. One ramification of these problems is that small items such as the pointer-driven cursor 408 can be moved by the operating system from a position in the visible area 410 to a position in the logical area 412, where the cursor is not visible to the user. Additionally, the cursor may be displayed within the visible area 410 of the display, but the user may not be able to locate the cursor or distinguish the cursor from the content displayed (particularly where graphical content is displayed).

When the user cannot locate the cursor within the display, the natural inclination of the user is to make exaggerated motions utilizing the pointing device controlling the cursor so that the cursor may be detected as it sweeps across the display. However, depending on the sensitivity of the pointer tracking and the response time of the video subsystem, a user making large motions can repeatedly move the cursor between extreme logical locations—inadvertently moving the cursor from one off-screen location to another—without ever detecting the cursor because the cursor display mechanism is too slow or the cursor too small or vague to be distinguished as it crosses the visible (physical) portion of the logical display. Moreover, the user normally has no idea where the cursor logically lies in such circumstances, and thus has no way of knowing whether moving the pointer in a particular direction is actually moving the cursor parallel to the visible area, further from the visible area, or closer to the visible area.

The opacity of a pointer-driven cursor is also occasionally problematic. When viewing an application image 404, the user is frequently frustrated by the presence of the pointer-driven cursor 408 in a position that obstructs a portion of the application image being viewed. User movement of the cursor may not alleviate the problem in such situations since the user, engrossed by the content, does not consider where to place the cursor within the display in order to avoid having the cursor obstruct other content which the user will later wish to view.

No comprehensive and adequate solution to the problems of a pointer-driven cursor exists. For locating an “invisible” cursor, some systems offer a “comet tail” mechanism by which the cursor momentarily leaves a trail of images as it crosses the screen. However, many users find such behavior annoying, and the cursor tail may not be visible for the same reason that the cursor is not visible if the graphics subsystem is slow to respond to rapid pointer movement.

For eliminating obstruction by a cursor, one proposed solution calls for a system to obscure the pointer-driven cursor during typing, but does not address the problem of users who are simply reading a document or otherwise viewing content. Additionally, the proposed solution completely removes the cursor from the screen, leading to confusion as to the cursor's status when the user again needs to employ the cursor. Another proposed solution causes a system to change the orientation of a cursor near the edge of the visible logical area, but does nothing to assist in locating a cursor which is already lost.

It would be desirable, therefore, to establish a comprehensive, flexible user control over the display of a pointer-driven cursor, allowing the user to quickly locate a cursor which the user cannot find and to selectively obscure the cursor when its prominence proves annoying.

### SUMMARY OF THE INVENTION

It is therefore one object of the present invention to control displays in data processing systems.

It is another object of the present invention to adjust the visibility of cursors in the user interface of data processing systems.

It is yet another object of the present invention to selectively reduce or increase the visibility of a pointer-driven cursor in a display.

The foregoing objects are achieved as is now described. When a user actuates a first control input signaling the user's desire to see the cursor prominently displayed, a cursor display control module displays the pointer-driven cursor in a predetermined display position prominently visible to the user. The prominence of the cursor may be enhanced by altering the cursor's attributes or altering the attributes of the background around the cursor; for example, by altering the cursor's size or shape, by causing the cursor to blink, by changing the background color in the area around the cursor, etc. When the user actuates a second control input signaling the user's desire to reduce visibility of the pointer-driven cursor, the cursor display control module obscures the pointer-driven cursor, for example, by moving the pointer-driven cursor to a less prominent position, by changing the color of the pixels that represent the pointer-driven cursor to reduce its visibility, or both.

The above as well as additional objectives, features, and advantages of the present invention will become apparent in the following detailed description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a data processing system equipped with a cursor display control module in accordance with a preferred embodiment of the present invention;

FIG. 2 is a diagram of the components of a data structure containing user preferences in accordance with a preferred embodiment of the present invention;

FIG. 3 depicts a high level flow chart of a process to control the visibility of a pointer-driven cursor in accordance with a preferred embodiment of the present invention; and

FIG. 4 is a pictorial representation of a graphical user interface display with a pointer-driven cursor illustrating the problems of the prior art.

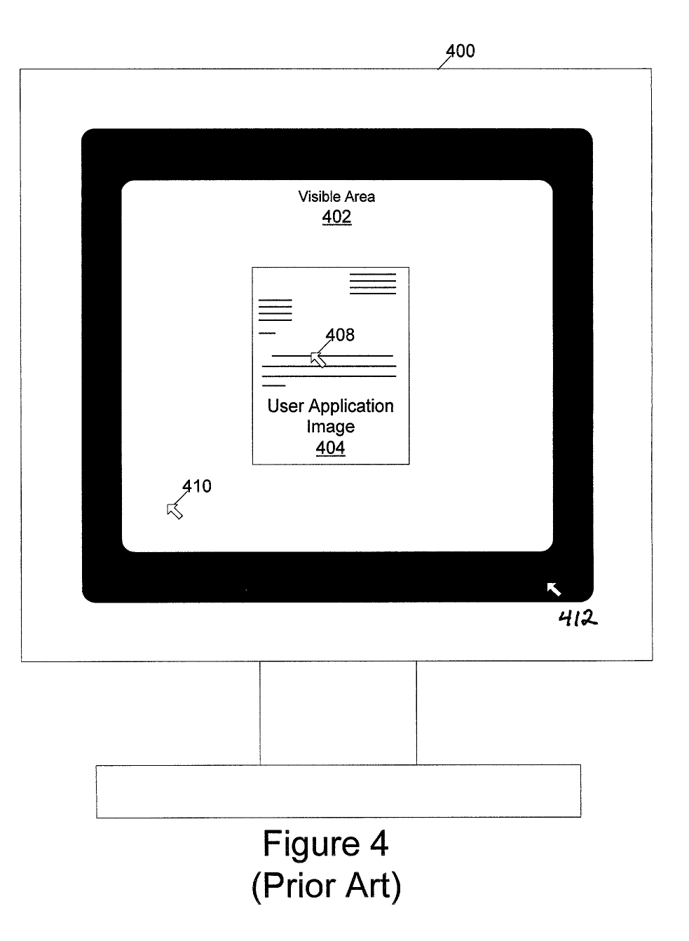

### DETAILED DESCRIPTION

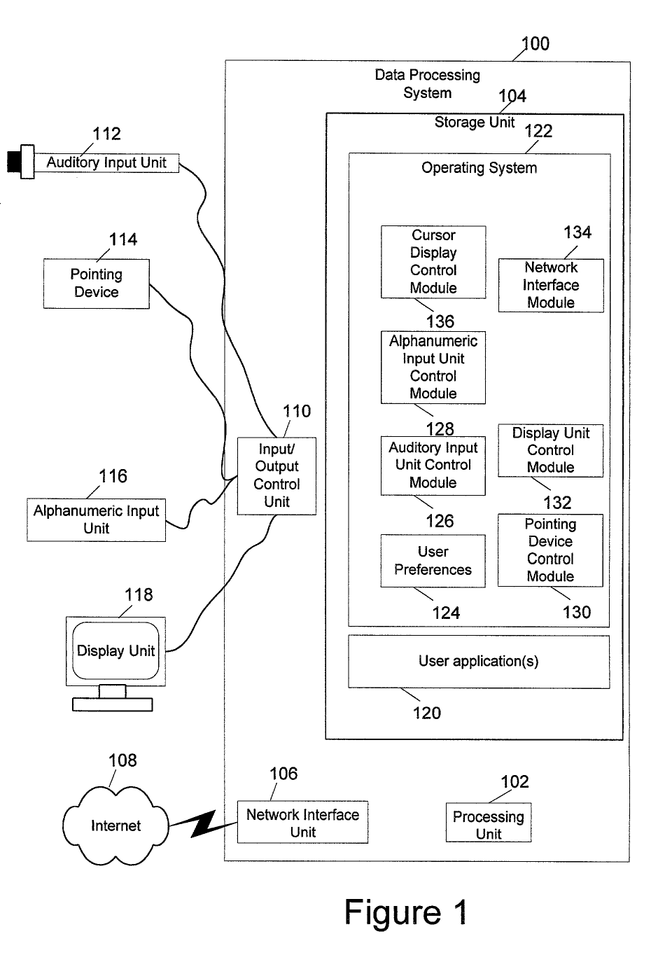

With reference now to the figures, and in particular with reference to FIG. 1, a data processing system equipped with a cursor display control module in accordance with the preferred embodiment of the present invention is depicted. The data processing system 100 includes a processing unit 102, typically composed of a microprocessor and supporting hardware, a storage unit 104 such as a memory, and a network interface unit 106 for connecting to a data processing system network such as the Internet 108. The data processing system 100 also includes an input/output control unit 110 that allows interface with a variety of peripheral devices. Peripheral devices shown include an auditory input unit 112, a pointing device 114 such as a mouse or joystick, an alphanumeric input unit 116 such as a keyboard, and a display unit 118 such as a monitor. Other peripheral devices may be substituted for those shown without deviating from the spirit and scope of the invention.

Storage unit 104 of the data processing system 100 contains a variety of data including programs selectively executable on the data processing system 100. Such programs include user applications 120 and an operating system 122. The user applications 120 may include all manner of programs ranging from spreadsheets to Internet telephony, while operating system 122 facilitates the interaction between a given application and the system hardware, as well as the interactions between applications. Constituent parts of the operating system 122 in the preferred embodiment of the present invention include, but are not limited to, a data structure for storing user preferences 124, an auditory input unit control module 126, an alphanumeric input unit control module 128, a pointing device control module 130, a display unit control module 132, a network interface module 134, and a cursor display control module 136. Additional software components may also be present in the operating system but are not critical to the present invention, and substitutions for some of the modules shown may be made while still carrying out the present invention.

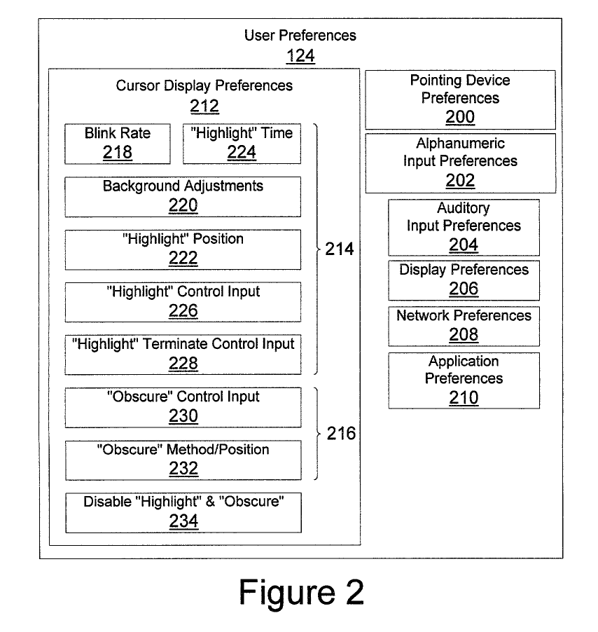

Referring to FIG. 2, which is to be read in conjunction with FIG. 1, a diagram of the components of a data structure containing user preferences in accordance with a preferred embodiment of the present invention is presented. Many user preferences will exist and may relate to both the operating system 122 and the user applications 120, but only the user preferences most relevant to the practice of the present invention are shown in this diagram. Various classes of user preferences exist. Among them, pointing device preferences 200 control the interaction of the data processing system and operating system with a pointing device 114 used to provide input to the data processing system. Likewise, alphanumeric input preferences 202 enable the user to configure the way in which data from the alphanumeric input unit 116 is interpreted by the data processing system. Auditory input preferences 204 provide this same function for the auditory input unit 112. Display preferences 206 control the way in which a display unit 118 presents data to the user while network preferences 208 control the ability of the data processing system to interact with other data processing systems over a network such as the Internet 108 and application preferences 210 provide the user with the ability to configure user applications 120 that run on the data processing system. Each of the user applications 120 may also have additional sets of user preferences stored in other locations on the data processing system, as may some items of hardware.

The set of user preferences 124 most relevant to the preferred embodiment of the present invention is the set of cursor display preferences 212 that relate to the cursor display control module 136. The individual data variables of this particular portion of the user preferences 124 data structure are shown in greater detail than those for other user preferences in order to provide structural insight into the operational discussions below.

Cursor display preferences 212 may contain conventional settings (not shown) for cursor shape and color, movement speed, button assignments for the pointing device, etc. In addition, cursor display preferences 212 includes settings 214 for the cursor reveal or “highlight” function and settings 216 for the cursor “obscure” function. Cursor highlight settings 214 include a blink rate 218 designating how fast the cursor should intermittently blink (i.e., alternate between being transparent and being opaque, or alternate between selected colors) when “highlighted” or increased in display prominence. Blink rate 218 may be set to zero to retain steady-state display of the cursor.

Cursor highlight settings 214 may also include: background adjustments 220 specifying whether and how (e.g., which color) the background area behind and/or immediately surrounding the cursor is altered when the cursor is high lighted; revealed or highlight position 222, identifying the user programmable display location to which the cursor is moved (e.g., center of active window, center screen, title bar, etc.) as part of highlighting the cursor; and highlight time 224, specifying the period for which the attributes of the cursor are altered when the cursor is increased in visible prominence.

User preferences for the highlight control input 226 specify the user control (e.g., hot key sequence or combination) which is employed to highlight the cursor, while highlight terminate control input 228 specifies the user control which is employed to manually terminate highlighting of the cursor prior to expiration of the period specified in highlight time 224. The same user control may be utilized to highlight the cursor and to manually terminate highlighting of the cursor, with the control operating differently depending on whether the cursor is highlighted at the time the user control is actuated.

Cursor highlight settings 214 thus enable:

1. a programmable key sequence (or mouse sequence, or combination mouse/key sequence) to increase the display prominence of the cursor (226);

2. a programmable time during which the increased display prominence of the cursor is maintained, absent terminating events (224);

3. a programmable location to place the cursor to increase the display prominence of the cursor (222);

4. a programmable timer for determining the rate at which the cursor blinks (218);

5. a programmable color/pattern used for the background area immediately surrounding the cursor (220); and

6. a programmable mechanism for terminating the increased display prominence of the cursor (228).

The programmable mechanism for terminating the increased display prominence of the cursor may be any event or action, such as hitting a keyboard key, clicking a mouse button, moving the mouse, hitting a specific key sequence, hitting a specific mouse button sequence, time-out, or any combination thereof. Any one of these events or actions are referred to herein as a predetermined discrete user input. A predetermined discrete user input is utilized to increase and/or decrease the display prominence of the cursor. The term discrete is used to clarify that the cursor is not moved to a predetermined location merely as a result of input directly caused by a corresponding movement of the mouse.

In the present invention, movement of the cursor to increase the cursor's display prominence may be selectively programmed to occur only when the cursor is located outside the viewable area of the logical display mapping. When the cursor is already positioned within the visible area of the display, the cursor could be maintained within its current location and only the remaining steps of increasing display prominence performed.

User preferences for cursor obscure settings 216 include a obscure control input 230, specifying the user control which is employed to obscure the cursor, and an obscure method/position 232, which specifies how the cursor is “obscured.” The cursor may be literally obscured by rendering the cursor transparent or by suppressing display of the cursor. Alternatively, the cursor may be obscured by moving the cursor to a logical portion of the display mapping which is not visible, or to a predetermined portion of the display (a user selected programmable location) where the cursor is unlikely to interfere with any content display (e.g., within the title bar, status line, or menu area).

The user preferences 124 also include disable switches parameter 234 allowing the user to toggle the availability of the cursor highlight and obscure functions which control increasing and decreasing the prominence of the cursor in the display.

As an example of how the cursor display preferences 212 are employed in the present invention, the system may be programmed such that the key sequence CTRL+ALT+F2 causes the cursor to:

1. move to the center of the visible portion of the display; and

2. for ten seconds, cause:

a. the cursor to blink rapidly; and

b. the screen background surrounding the cursor to assume a speckled pattern and bright orange color designed to attract the user's eye.

The key sequence CTRL+ALT+F2, when actuated before expiration of the ten seconds, would cause the cursor to stop blinking and return the surrounding area to the normal color and pattern. The system may concurrently be programmed such that the key sequence CTRL+ALT+F3 causes the cursor to move to the title bar and become transparent.

User preferences 124 will typically be embodied as a set of stored variables in the storage unit 104 of a data processing system and will typically be part of the operating system, although some applications may call for the storage of user preferences on a network such as the Internet 108, where they can be accessed though the use of the network interface unit 106.

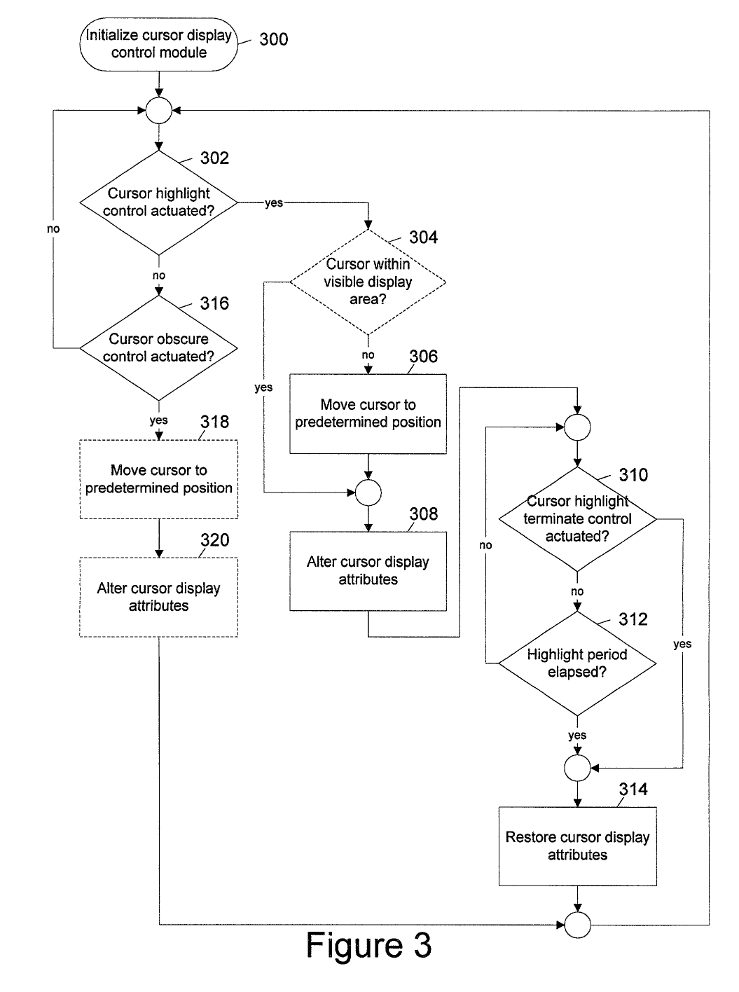

With reference now to FIG. 3, which is intended to be read in conjunction with the previous figures, a high level flow chart for a process of controlling the display of a pointer-driven cursor in accordance with the preferred embodiment of the present invention is depicted. The process begins at step 300, which depicts the operating system 122 initializing the cursor control display module 136. The process next passes to step 302, which illustrates determining if the user has applied the predefined pointer highlight sequence stored in the highlight control input 226. A highlight control input sequence could be any predetermined input from alphanumeric input unit 116, the pointing device 114, or the auditory input unit 112, or other input system not depicted, that would alert the system to place the pointer-driven cursor at a predetermined location with the user-specified properties (blink rate, background pattern/color, etc.).

If the input sequence has been applied, the process proceeds to step 304, which depicts the optional step of determining whether the current cursor location is within the visible area of the display mapping. If so, the process may optionally skip to step 308. Otherwise, and if step 304 is not implemented, the process proceeds to step 306, which illustrates display of the cursor at a user-selected location. Therefore, in the event that the cursor had been moved by the user from a position in the visible area of a display to a position in the invisible, logical display area, the user may enter a command sequence which will return the cursor to a preselected position within the visible area. The process may optionally be configured to determine whether the cursor is within the visible display area before moving the cursor, and moving the cursor only if it lies outside the visible display area.

After the cursor has been placed in a visible position, the process passes to step 308, which depicts the pointer-driven cursor being distinguished utilizing user-specified display properties (e.g., background pattern/color, blink rate, cursor attributes, etc.). This can be accomplished, for example, by changing the color of the background in the area adjacent to the pointer-driven cursor, by causing the pointer driven cursor to blink, or by changing the pointer-driven cursor's attributes, etc. The user preference for background adjustments 220 will contain a set of variables controlling whether the color of the area around the pointer-driven cursor is changed, the color(s) and pattern to which the area changes, and the size of the area effected. The user preference data item for blink rate 218 will contain variables that will determine whether the cursor blinks and the rate at which the cursor blinks. These items will typically, though not necessarily, be user-configurable.

The process next proceeds to step 310, which depicts the determination of whether the user has applied a highlight terminate control sequence as stored in the user preferences. The highlight terminate sequence may be any predetermined input from alphanumeric input unit 116, the pointing device 114, or the auditory input unit 112, or other input system not depicted, that would alert the system that the user is now aware of the cursor location and desires to terminate the increased display prominence of the cursor. In the event that the sequence has not been applied, the process proceeds to step 312, which depicts determining whether a predetermined highlight period, specified in the user preferences, has elapsed. If the predetermined highlight period has elapsed, or if the user has input the predetermined terminate sequence, the process proceeds instead to step 314, which illustrates restoring the normal display properties of the cursor, then returns to step 302.

As stated, the cursor highlight control sequence and the position to which the cursor is moved will typically be options that can be configured by the user and are stored in the user preferences 124 by the operating system 122. Likewise, the manner in which the pointer-driven cursor is distinguished from the remainder of the display in order to increase the display prominence of the cursor will typically be configured by the user. The user will typically be able to determine whether the color of the background surrounding the cursor is changed, what color the background surrounding the cursor becomes, whether the cursor blinks, the rate at which the cursor blinks, what input sequence, if any, ends the process of distinguishing the cursor from the surrounding background, and what length of time, if any, is an adequate period for highlighting the cursor.

Returning to step 302, if the user has not applied the cursor highlight control sequence, then the process passes to step 316, which depicts a determination of whether the user has applied an input sequence to request that the cursor be obscured. A cursor obscure sequence will typically be stored in the obscure control input 230 of the user preferences and could be any predetermined input from alphanumeric input unit 116, the pointing device 114, or the auditory input unit 112, or other input system not depicted which would alert the system to reduce the visual prominence of the pointer-driven cursor. If the user has applied the cursor obscure sequence, the process then proceeds to step 318, which depicts the system obscuring the cursor by reducing the visual prominence of the cursor within the display. The visual prominence of the cursor within the display may be accomplished by a variety of means, such as moving the cursor to a predetermined location or making the cursor transparent or invisible. The means by which the visual prominence of the cursor is to be reduced will typically be chosen by the user and stored in the obscure method/position 232 attribute of the user preferences data structure 124. In the preferred embodiment, the visual prominence of the cursor would typically be reduced by moving the pointer driven cursor to a predetermined display location and concurrently suppressing display of the cursor.

Steps 318 and 320, which depict moving the cursor to a predetermined display location and altering the cursor display attributes, respectively, are depicted as optional within FIG. 3 since either or both steps may be implemented. However, at least one of the two steps should be implemented. After completing one or both of step 318 and 320, the process returns to step 302. Similarly, if the user is determined not to have applied the cursor obscure sequence at step 316, the process returns to step 302.

In the preferred embodiment, the visual prominence of the cursor would typically be reduced by moving the pointer driven cursor to a display location and altered in display appearance according to specifications stored in the obscure method/position 232 variable of the user preferences data structure.

The present invention provides a mechanism allowing the user to control the visibility of the cursor—either by increasing the display prominence or reducing the display prominence—in a manner not available in the prior art. Though all of the flexibility described above will typically be offered in the preferred embodiment, other embodiments of the present invention need not include the flexibility for the user to configure some or all of these options and may depend on non-configurable variables without departing from the spirit and scope of the present invention.

It is important to note that while the present invention has been described in the context of a fully functional data processing system and/or network, those skilled in the art will appreciate that the mechanism of the present invention is capable of being distributed in the form of a machine usable medium of instructions in a variety of forms, and that the present invention applies equally regardless of the particular type of signal bearing medium used to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and CD-ROMs, and transmission type mediums such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method of controlling the visibility of a pointer-driven cursor, comprising:
responsive to a first user-control input, increasing a display prominence of a pointer-driven cursor; and
responsive to a second user-control input, reducing the display prominence of the pointer-driven cursor.

2. The method of claim 1, wherein the step of increasing a display prominence of a pointer-driven cursor further comprises:
moving the cursor to a predetermined display location.

3. The method of claim 2, wherein the step of moving the cursor to a predetermined display location further comprises:
independent of a current location of the cursor, moving the cursor to a center of a viewable display area.

4. The method of claim 1, wherein the step of increasing a display prominence of a pointer-driven cursor further comprises:
moving the cursor to a predetermined display location only if a current location of the cursor is not within a visible area.

5. The method of claim 1, wherein the step of increasing a display prominence of a pointer-driven cursor further comprises:
altering at least one defining attribute of the cursor.

6. The method of claim 1, wherein the step of increasing a display prominence of a pointer-driven cursor further comprises:
altering at least one defining attribute of a background area surrounding the cursor.

7. The method of claim 1, wherein the step of increasing a display prominence of a pointer-driven cursor further comprises:
moving the cursor to a predetermined display location;
altering at least one defining attribute of the cursor; and
altering at least one defining attribute of a background area surrounding the cursor.

8. The method of claim 1, wherein the step of reducing the display prominence of the pointer-driven cursor further comprises:
responsive to a predefined user input sequence, hiding the cursor.

9. The method of claim 1, further comprising:
responsive to a third user-control input while the display prominence of the cursor is increased, restoring the display appearance of the cursor to normal.

10. The method of claim 1, further comprising:
responsive to elapse of a predefined period after the display prominence of the cursor is increased, restoring the display appearance of the cursor to normal.

11. The method of claim 1, wherein the step of reducing the display prominence of the pointer-driven cursor further comprises:
moving the cursor to a predetermined display location.

12. The method of claim 1, wherein the step of reducing the display prominence of the pointer-driven cursor further comprises:
suppressing display of the cursor.

13. The method of claim 1, wherein the step of reducing the display prominence of the pointer-driven cursor further comprises at least one of:
moving the cursor to a predetermined display location; and
suppressing display of the cursor.

14. A method of controlling the visibility of a pointer-driven cursor, comprising:
responsive to a first user-control input while a cursor is being normally displayed, increasing a display prominence of the cursor by at least one of:
moving the cursor to a first predetermined display location if a current location of the cursor is not within a visible area of a display;
altering at least one attribute of the cursor; and
altering at least one attribute of a background area surrounding the cursor;
responsive to either
the first user-control input, or
elapse of a predetermined period while the cursor is being displayed with increased display prominence, restoring a normal appearance of the cursor; and
responsive to a second user-control input while the cursor is being normally displayed, reducing the display prominence of the pointer-driven cursor by at least one of:
moving the cursor to a second predetermined display location; and
suppressing display of the cursor.

15. The method of claim 14, wherein the step of moving the cursor to a first predetermined display location if a current location of the cursor is not within a visible area further comprises:
moving the cursor to a center of an active window;
moving the cursor to a prominent location of a visible display area; and
moving the cursor to a center of a visible display area.

16. The method of claim 14, wherein the step of moving the cursor to a second predetermined display location further comprises:
moving the cursor to a location selected from at least one of a title bar, a status line, a menu area, and a less prominent location of a display area.

17. A method for controlling movement of a cursor on a display, comprising:
receiving a predetermined discrete user input; and
responsive to receiving the predetermined discrete user input, displaying a pointer-driven cursor at a predetermined position on the display independent of a previous display position of the pointer-driven cursor.

18. The method of claim 17, further comprising:
receiving a preselected discrete user input prior to receiving the predetermined discrete user input; and
responsive to receiving the preselected discrete user input, hiding the pointer-driven cursor.

19. A system for controlling the visibility of a pointer-driven cursor, comprising:
a display in which a pointer-driven cursor is displayed;
means, responsive to a first user-control input, for increasing a display prominence of the pointer-driven cursor; and
means, responsive to a second user-control input, for reducing the display prominence of the pointer-driven cursor.

20. The system of claim 19, wherein the means for increasing the display prominence of the pointer-driven cursor further comprises at least one of:
means for moving the cursor to a predetermined location within the display;
means for altering at least one attribute associated with display of the cursor; and
means for altering at least one attribute associated with a background area surrounding the cursor.

21. The system of claim 20, wherein the means for moving the cursor to a predetermined location within the display further comprises:
means for moving the cursor to a prominent location of a visible display area of the display if a current location of the cursor is not within the visible display area.

22. The system of claim 20, wherein the means for altering attributes associated with display of the cursor or altering a background area surrounding the cursor further comprises at least one of:
means for causing the cursor to blink at a predetermined rate;
means for temporarily changing a size of the cursor;
means for temporarily changing a shape of the cursor; and
means for altering a color or pattern for display of the background area surrounding the cursor.

23. The system of claim 19, wherein the means for reducing the display prominence of the pointer-driven cursor further comprises at least one of:
means for moving the cursor to a predetermined location; and
means for suppressing display of the cursor.

24. The system of claim 19, further comprising:
means, responsive to a third user-control input while the display prominence of the cursor is increased, for restoring a display appearance of the cursor to normal.

25. A system for controlling the visibility of a pointer-driven cursor, comprising:
a data processing system including a display and a user input, the display having a visible display area;
means, responsive to a first user-control input while a cursor is being normally displayed, for increasing a display prominence of the cursor by at least one of:
moving the cursor to a first predetermined display location if a current location of the cursor is not within the visible display area,
changing at least one attribute associated with display of the cursor, and
changing at least one attribute associated with a background area surrounding the cursor;
means, responsive to either the first user-control input or elapse of a predetermined period while the cursor is being displayed with increased display prominence, for restoring a normal appearance of the cursor; and
means, responsive to a second user-control input while the cursor is being normally displayed, for reducing the display prominence of the pointer-driven cursor by at least one of:
moving the cursor to a second predetermined display location, and
suppressing display of the cursor.

26. The system of claim 25, wherein the means for changing at least one of attributes associated with display of the cursor and a background area surrounding the cursor further comprises at least one of:
means for causing the cursor to blink at a predetermined rate;
means for temporarily changing a shape of the cursor;
means for temporarily changing a size of the cursor; and
means for altering a color or pattern for the background area surrounding the cursor.

27. The system of claim 25, wherein the first predetermined display location is a location selected from at least one of the following: a center of an active window, a center of the visible display area, and a prominent location of the visible display area.

28. The system of claim 25, wherein the second predetermined display location is a location selected from at least one of a title bar, a status line, a menu area, and a less prominent location of the display area.

29. A system for controlling movement of a cursor on a display, comprising:
means for receiving a predetermined discrete user input; and
means, responsive to receiving the predetermined discrete user input, for displaying a pointer-driven cursor at a predetermined position on the display independent of a previous display position of the pointer-driven cursor.

30. The system of claim 29, further comprising:
means for receiving a preselected discrete user input prior to receiving the predetermined discrete user input; and
responsive to receiving the preselected discrete user input, hiding the pointer-driven cursor.

31. A computer program product within a machine usable medium for controlling the visibility of a pointer-driven cursor, comprising:
instructions, responsive to a first user-control input, for increasing a display prominence of a pointer-driven cursor; and
instructions, responsive to a second user-control input, for reducing the display prominence of the pointer-driven cursor.

32. The computer program product of claim 31, wherein the instructions for increasing a display prominence of a pointer-driven cursor further comprise:
instructions for performing at least one of:
moving the cursor to a first predetermined location if a current location of the cursor is not within the visible display area,
changing at least one attribute associated with display of the cursor, and
changing at least one attribute associated with a background area surrounding the cursor.

33. The computer program product of claim 32, wherein the instructions for moving the cursor to a first predetermined location if a current location of the cursor is not within the visible display area further comprise at least one of:
instructions for moving the cursor to a location selected from a center of an active window, a center of a visible display area, and a prominent location of a visible display area.

34. The computer program product of claim 32, wherein the instructions for changing at least one of attributes associated with display of the cursor and a background area surrounding the cursor further comprise at least one of:
instructions for causing the cursor to blink at a predetermined rate;
instructions for temporarily changing a shape of the cursor;
instructions for temporarily changing a size of the cursor; and
instructions for altering a color or pattern for the background area surrounding the cursor.

35. The computer program product of claim 31, wherein the instructions for reducing the display prominence of the pointer-driven cursor further comprise:
instructions for performing at least one of:
moving the cursor to a location selected from a title bar, status line, menu area, and a less prominent location of the visible display area; and
suppressing display of the cursor.

36. The computer program product of claim 33, further comprising:
instructions, responsive to a third user-control input while the display prominence of the cursor is increased, for restoring a display appearance of the cursor to normal.

37. A computer program product within a machine usable medium for controlling the visibility of a pointer-driven cursor, comprising:
instructions, responsive to a first user-control input while a cursor is being normally displayed, for increasing a display prominence of the cursor by at least one of:
moving the cursor to a first predetermined display location if a current location of the cursor is not within the visible display area,
altering at least one display attribute associated with the cursor, and
altering at least one display attribute associated with a background area surrounding the cursor;
instructions, responsive to either the first user-control input or elapse of a predetermined period while the cursor is being displayed with increased display prominence, for restoring a normal appearance of the cursor; and
instructions, responsive to a second user-control input while the cursor is being normally displayed, for reducing the display prominence of the pointer-driven cursor by at least one of:
moving the cursor to a second predetermined display location, and
suppressing display of the cursor.

38. The computer program product of claim 37, wherein instructions for moving the cursor to a first predetermined display location if a current location of the cursor is not within the visible display area further comprising:
instructions for moving the cursor to a location selected from a center of an active window, a center of the visible display area, and a prominent location of a visible display area.

39. The computer program product of claim 36, wherein the instructions for moving the cursor to a second predetermined display location further comprise:
instructions for moving the cursor to one of a title bar, a status line, a menu area, and a less prominent location of the display area.

40. A computer program product within a computer usable medium for controlling movement of a cursor on a display, comprising:
instructions for receiving a predetermined discrete user input; and
instructions, responsive to receiving the predetermined discrete user input, for displaying a pointer-driven cursor at a predetermined position on the display independent of a previous display position of the pointer-driven cursor.

41. The computer program product of claim 40, further comprising:
instructions for receiving a preselected discrete user input prior to receiving the predetermined discrete user input; and
responsive to receiving the preselected discrete user input, hiding the pointer-driven cursor.
